(19) United States
(12) Patent Application Publication
(10) Pub. No.: US 2006/0193946 A1
(43) Pub. Date: Aug. 31, 2006

(54) Edible compositions containing gelling silicates

(75) Inventors: Petros Gebreselassie, Piscataway, NJ (US); Navroz Boghani, Flanders, NJ (US)

Correspondence Address: HOFFMANN & BARON, LLP, 6900 JERICHO TURNPIKE, SYOSSET, NY, 11791, US

(73) Assignee: CADBURY ADAMS USA LLC.

(21) Appl. No.: 11/344,887

(22) Filed: Feb. 1, 2006

Related U.S. Application Data
(60) Provisional application No. 60/656,172, filed on Feb. 25, 2005.

(51) Int. Cl. A23G 4/00

(52) U.S. Cl. 426/3

(57) ABSTRACT

A swellable chewing gum composition comprising: (a) a gum base; and (b) at least one water-gelling or water-swellable silicon-containing component selected from the group consisting of silicates, silicas, and combinations thereof.

### CROSS-REFERENCE TO RELATED APPLICATIONS

This application claims the benefit of U.S. Provisional Application No. 60/656,172, filed Feb. 25, 2005, the contents of which are incorporated herein by reference.

### FIELD

The present invention relates to swellable edible or comestible compositions which include a carrier matrix, and at least one water-gelling or water-swellable silicone-containing component. In some embodiments, the carrier matrix is a chewing gum base and the edible composition is a chewing gum composition.

### BACKGROUND

Conventional chewing gums often lose their elasticity as they are chewed. The result is a harder “chew” and a less desirable mouth feel. This is because the chewing gum components which contribute to the gum's softness are generally water soluble. The act of chewing gum dissolves these components in the saliva, leaving behind the chewing gum base. As a result, the bolus of the gum is substantially decreased in size, becoming rubbery and harder to masticate. As the water-solubles are removed with water, the gum is also less juicy.

The more the gum is chewed, the more softening agent is removed from the chewing gum. When deprived of the softening agents, this polymeric gum base composition tends to become tough and rubbery. This results in an unpleasant tactile sensation in the chewer's mouth. The chewing gum is generally discarded at this stage, as further chewing of the hard polymeric composition is less pleasing to the consumer.

Additionally, densification or increased hardness and a decrease in the hydrophilicity of the chewing gum composition serves as an impediment to further flavor release by the chewing gum. Flavoring ingredients in conventional chewing gums are generally water soluble and are released to the user upon exposure of these ingredients to saliva. However, as the chewing gum becomes harder and more rubbery, an increasingly hydrophobic environment is created, with the result that any flavoring ingredients trapped in the chewing gum are not exposed to saliva or water and are not released to the chewer. This reduces the pleasantness of the taste and results in an inefficient use of the flavoring ingredients, as much of these ingredients is discarded with the tough, rubbery composition.

Accordingly, there is a need for a chewing gum composition which is able to maintain its soft consistency even after extended chewing.

### BRIEF DESCRIPTION OF THE DRAWINGS

FIG. 1 is a graph showing the results of flavor intensity chew panels of three inventive compositions (Compositions 2, 3, and 5) as compared to a control (Composition 6).

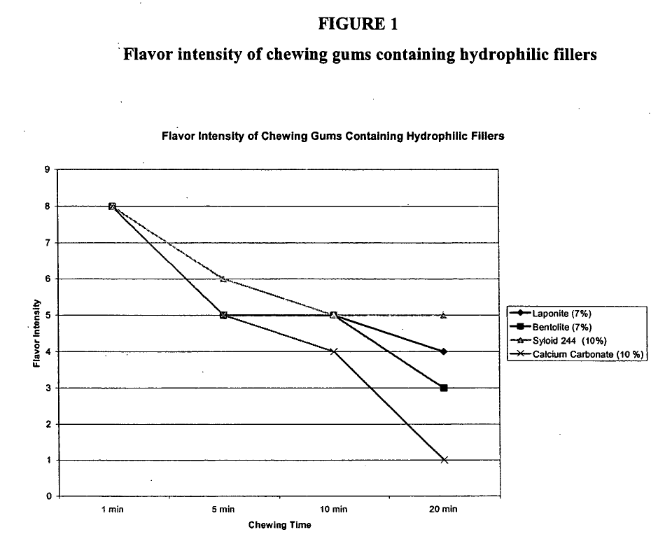

FIG. 2 is a graph showing the results of softness chew panels of three inventive compositions (Compositions 2, 3 and 5) as compared to a control (Composition 6).

FIG. 3 is a graft showing the results of chew panels measuring increased swelling of three inventive compositions (Compositions 2, 3 and 5) as compound to a control (Composition 6).

### SUMMARY

The inventive compositions may include at least one water-swellable or water-gelling silicon-containing component in combination with a carrier matrix such as a gum base, or at least one water-gelling or water-swellable silicon-containing component as a component of a carrier matrix such as a gum base.

In some embodiments, there is provided a swellable chewing gum composition which may include a gum base, and at least one water-gelling or water-swellable Silicon (Si-) containing component selected from the group consisting of silicates, silicas, and combinations thereof.

The Si-containing component may be a hygroscopic composition that absorbs water from the chewer's saliva. The ionic nature of the Si-containing components creates an attraction for water molecules in the chewing gum composition. As the water content of the chewing gum composition increases, the chewing gum composition increases in volume and as a result, becomes softer. The texture of the chewing gum can remain soft and smooth, which may avoid the disadvantages associated with conventional chewing gums mentioned hereinabove.

Moreover, the Si-containing component contributes to a more efficient release of flavoring and sweetening ingredients from the composition by increasing absorption of saliva (water) into the gum base. As more water is absorbed into the chewing gum composition of the invention, more of the flavoring and sweetening ingredients can be carries away with the saliva and are thereby released to the chewer.

Different Si-containing components possess different swelling properties, and different effects on the texture and consistency of the chewing gum compositions of the invention. A wide range of variables can therefore be controlled by the choice of the Si-containing component. In some embodiments, multiple Si-containing components are used.

In other embodiments, a method of preparing a swellable chewing gum composition which may include:
a. providing a gum base; and
b. mixing the gum base with at least one water-gelling or water-swellable Si-containing component selected from the group consisting of silicates, silicas, and combinations thereof.

### DETAILED DESCRIPTION

As used herein, the transitional term “comprising,” (also “comprises, etc.), which is synonymous with “including,” “containing,” or “characterized by,” is inclusive or open-ended and does not exclude additional, unrecited elements or method steps, regardless of its use in the preamble or the body of a claim.

As used herein, the terms “bubble gum” and “chewing gum” are used interchangeably and are both meant to include any gum compositions.

Some embodiment of the present invention provide edible compositions having a carrier matrix, such as a candy matrix or a gum base matrix, and further including a silicon-containing component, which component absorbs moisture to improve the hydration and mouthfeel of the composition. In embodiments where the matrix is a chewable matrix, such as a gum composition or a nougat, frappe, taffy, or toffee the chew of the overall composition may be enhanced and may be softened. Additionally, absorption of water through saliva may serve to increase the volume of the matrix, as well as the weight. In embodiments which employ gum base as the chewable matrix, a combination of advantages may be achieved, such as softening, increased bolus volume and a perception of increased juiciness, increased bolus weight and overall heightened organoleptic perception and pleasure. In embodiments where the product is a chewing gum composition, the composition when chewed may resist becoming hard or rubbery as compared to conventional chewing gum compositions and as the compositions absorbs moisture from the mouth, the chewer may experience greater flavor and/or sweetener release.

The silicon-containing components of the present invention may be selected from a silica having a silicon dioxide (SiO₂) content which may vary. Desirably the SiO₂ content ranges from about 50% to about 99.6% by weight of the silicon-containing component. The source of silica may be from a variety of clay types, some of which are provided below, along with the brand name of the corresponding commercially available product.

Examples of Silicon-Containing Sources

Southern Clay

This type of clay is available commercially under several trademarks, such as Laponite RD and Bentolite. Laponite RD is a clay which may form thixotropic, heat stable gels when dispensed in water. Commercially, it is sold as a purified colloidal synthetic clay which may impart viscosity and suspension properties to the material to which it is added. A typical chemical analysis of the commercially available product as provided by the manufacturer is:

Laponite RD Synthetic Clay

| Component | wt % |
|---|---|
| SiO₂ | 59.5 |
| MaO | 27.5 |
| Li₂O | 0.8 |
| Na₂O | 2.8 |

Bentolite is produced from native colloidal silicate which possesses a high purity, whiteness and brightness. It possesses a small particle size and high surface area which permits absorption of high levels of liquids. The typical chemical analysis according to the manufacturer is represented by the following:

Bentolite Clay

| Component | wt % |
|---|---|
| SiO₂ | 68.1 |
| Al₂O₃ | 13.5 |
| MgO | 2.9 |
| Fe_{z}O₃ | 0.7 |
| CaO | 0.9 |
| Na₂O | 3.5 |
| K₂O | 0.1 |
| TiO₂ | 0.2 |

Precipitated silicas may also be employed. Such silicas are commercially available under the tradenames Syloid 244, available from WR Grace, and Tixosil 43, or 103, available from Rhone-Poulenc. The precipitated silicas may have a surface area as described by the Branauer-Emmet-Teller method (BET) of about 50 to about 400m ²/g and desirably about 100 to about 300 m ²/g. This BET method is described in the “Journal of the American Chemical Society”, vol. 60, page 309, February 1938 and corresponds to ISO standard 5764/1 (Appendix I), both of which are incorporated herein by reference.

Silicon-containing components employed may exhibit a dioctyl phthalate (DOP) oil-uptake of about 200 to about 400 m/100 g and desirably about 300 to about 350 ml/100 g. The DOP oil-uptake is measured according to ISO Standard 785/5, which is herein incorporated by reference.

Desirably, silicon-containing components with pore volumes of about 2.1 cm³/g to about 5 cm³/g are employed. Pore volume may be measured by mercury porosimetry.

The pH of the silicon-containing component may vary. Desirably the pH is between about 6 to about 8, and more desirably about 6.8 to about 7.5. The pH may be measured according to the ISO Standard 787/9 (pH suspension of a 5% suspension n water), which is incorporated herein by reference.

Chewing Gum Composition

Embodiments described herein provide a swellable chewing gum composition which includes a gum base and at least one water swellable silicate or/and silica.

The silicon-containing component of the present invention may be any synthetic or naturally occurring silicon-containing component known to those skilled in the art. Examples of such Si-containing components include, but are not limited, to those sold buy Southern Clay Products, Inc. under the tradenames: Laponite, Bentolite, Claytone, Garamite, Gelwhite, Cloisite, and Permont. Also useful in the present invention are Sylodent, sold by Grace, Inc., and Tixosil 43, sold by Rhodia. Silica (SiO₂) is also useful for the present invention. Advantageously, the Si-containing component is selected from the group consisting of Claytone, Bentolite, Laponite, Tixosil 43, and Syloid 244. More advantageously, the Si-containing component is Laponite. Combinations of Si-containing components may be used.

The softness of the chewing gum composition increases along with the concentration of Si-containing component. The Si-containing component may be present in an amount ranging from about 0.1% to about 50.0%. Advantageously, the Si-containing component is present in an amount of about 2% to about 10%. Different Si-containing components absorb water in different amounts and different rates. Accordingly, for example, a component such as Laponite® present in a small concentration would achieve the same effect as silica present in larger amounts. Laponite® contains layers of ions between which water migrates and forces apart, thereby increasing the volume and swelling the composition in which it is used.

The chewing gum composition of the present invention may swell to many times its original pre-mastication size upon absorption of water. In one embodiment, the composition, when swollen, may be about 1% to about 300% larger in volume when swollen due to the absorption of moisture (e.g., saliva). In an advantageous aspect, the composition may be about 25% to about 200% larger in volume when swollen.

The gum base used in the swellable chewing gum composition may be any conventional chewing gum base known to those skilled in the art.

The gum base may include any component known in the chewing gum art. For example, the gum base may include elastomers, bulking agents, waxes, elastomer solvents, emulsifiers, plasticizers, fillers, and mixtures thereof.

The elastomers employed in the gum base will vary greatly depending upon various factors such as the type of gum base desired, the consistency of the gum composition desired, and the other components used in the composition to make the final chewing gum product. The elastomer may be any water-insoluble polymer known in the art, and includes those gum polymers utilized for chewing gums and bubble gums. Both natural and synthetic elastomers are contemplated by the present invention. Illustrative examples include, but are not limited to, natural substances (of vegetable origin) such as chicle, natural rubber, crown gum, nispero, rosidinha, jelutong, perillo, niger gutta, tunu, balata, gutta-percha, lechi capsi, corva, gutta kay, and the like, and mixtures thereof. Examples of synthetic elastomers include, but are not limited to, styrene-butadiene copolymers (SBR), polyisobutylene, isobutylene-isoprene copolymers, polyethylene, polyvinyl acetate and the like, and mixtures thereof.

Additional useful polymers include: crosslinked polyvinyl pyrrolidone, polymethylmethacrylate; copolymers of lactic acid, polyhydroxyalkanoates, plasticized ethylcellulose, polyvinyl acetatephthalate and combinations thereof.

In some embodiments, the gum base may include at least one elastomer selected from the group consisting of natural rubber, styrene-butadiene copolymers (SBR), polyisobutylene, isobutylene-isoprene copolymers, polyethylene, polyvinyl acetate, crosslinked polyvinyl pyrrolidone, copolymers of lactic acid, polyhydroxyalkanoates, plasticized ethylcellulose, polyvinyl acetatephthalate, and combinations thereof.

The amount of elastomer employed in the gum base may vary depending upon various factors such as the type of gum base used, the consistency of the gum composition desired and the other components used, the amount or types of other components used, the consistency of the gum composition desired and the other components used in the composition to make the final chewing gum product. In general, the elastomer may be present in the gum base in an amount from about 10% to about 60% by weight, desirably from about 35% to about 40% by weight.

In some embodiments, the gum base may include wax. Wax may soften the polymeric elastomer mixture and improve the elasticity of the gum base. When present, the waxes employed may have a melting point below about 60° C., and preferably between about 45° C. and about 55C° C. The low melting max may be a paraffin wax. The wax may be present in an amount from about 6% to about 10%, and preferably from about 7% to about 9.5%, by weight of the gum base.

In addition to the low melting waxes, waxes having a higher melting point may be used in the gum base in amounts up to about 5% by weight of the gum base. Such high melting waxes include beeswax, vegetable wax, candelilla wax, carnuba wax, most petroleum waxes, and the like, and mixtures thereof.

The gum base may contain solvents to aid in softening the elastomer component. Such elastomer solvents may include those elastomer solvents known to those skilled in the art, which encompass terpinene resins such as polymers of alpha-pinene or beta-pinene, methyl, glycerol and pentaerythriol esters of rosins and modified rosins and gums such as hydrogenated, dimerized and polymerized rosins, and mixtures thereof. Illustrative examples of elastomer solvents suitable for use in the present invention include, but are not limited to, the pentaerythritol ester of partially hydrogenated wood and gum rosin, the pentaerythritol ester of wood and gum rosin, the glycerol ester of wood rosin, the glycerol ester of partially dimerized wood and gum rosin, the glycerol ester of polymerized wood and gum rosin, the glycerol ester of tall oil rosin, the glycerol ester of wood and gum rosin and partially hydrogenated wood and gum rosin and the partially hydrogenated methyl ester of wood and rosin, and the like, and mixtures thereof. The elastomer solvent may be employed in the gum base in amounts from about 2% to about 15%, and preferably from about 7% to about 11% by weight of the gum base.

The gum base may also include emulsifiers which aid in dispersing the immiscible components into a single stable system. The emulsifiers useful in this invention include glyceryl monostearate, lecithin, fatty acid monoglycerides, diglycerides, propylene glycol monostearate, and the like, and mixtures thereof. The emulsifier may be employed in amounts from about 2% to about 15%, and more specifically, from about 7% to about 11%, by weight of the gum base.

The gum base may also include plasticizers or softeners to provide a variety of desirable textures and consistencies. Because of the low molecular weight of these ingredients, the plasticizers and softeners are able to penetrate the fundamental structure of the gum base, making it plastic and lest viscous. Useful plasticizers and softeners include lanolin, palmitic acid, oleic acid, stearic acid, sodium stearate, potassium stearate, glyceryl triacetate, glyceryl lecithin, glyceryl monostearate, propylene glycol monostearate, acetylated monoglyceride, glycerine, styrene-butadiene copolymer, isobutylene-isoprene copolymer, polyisobutylene, and the like, and mixtures thereof. Waxes (synthetic and natural), hydrogenated vegetable oils, petroleum waxes such as polyurethane waxes, polyethylene waxes, paraffin waxes, microcrystalline waxes, fatty waxes, sorbitan monostearate, tallow, propylene glycol, mixtures thereof, and the like, may also be incorporated into the gum base. The plasticizers and softeners may be generally employed in the gum base in amounts up to about 20% by weight of the gum base, and more specifically in amounts from about 9% to about 17%, by weight of the gum base.

Plasticizers also include hydrogenated vegetable oils, such as soybean oil and cottonseed oils, which may be employed alone or in combination. These plasticizers provide the gum base with good texture and soft chew characteristics. These plasticizers and softeners may be generally employed in amounts from about 5% to about 14%, and more specifically in amounts from about 5% to about 13.5%, by weight of the gum base.

Anhydrous glycerin may also be employed as a softening agent, such as the commercially available United States Pharmacopeia (USP) grade. Glycerin is a syrupy liquid with a sweet warm taste and has a sweetness of about 60% of that of cane sugar. Because glycerin is hygroscopic, the anhydrous glycerin may be maintained under anhydrous conditions throughout the preparation of the chewing gum composition.

In some embodiments, the gum base of this invention may also include effective amounts of bulking agents such as mineral adjuvants which may serve as fillers and textural agents. Useful mineral adjuvants include, in addition to any other such mineral adjuvants noted herein, calcium carbonate, magnesium carbonate, alumina, aluminum hydroxide, aluminum silicate, talc, tricalcium phosphate, dicalcium phosphate, calcium sulfate and the like, and mixtures thereof. These fillers or adjuvants may be used in the gum base compositions in various amounts. Preferably the amount of filler, when used, will be present in an amount from about 15% to about 40% and desirably from about 20% to about 30% by weight of the gum base.

A variety of traditional ingredients may be optionally included in the gum base in effective amounts such as the flavor agents and coloring agents described above, antioxidants, preservatives, and the like. For example, titanium dioxide and other dyes suitable for food, drug, and cosmetic applications, known as F.D. & C. dyes, may be utilized. An anti-oxidant such as butylated hydroxytoluene (BHT), butylated hydroxyanisole (BHA), propyl gallate, vitamin E, and mixtures thereof, may also be included. Other conventional chewing gum additives known to those skilled in the art may also be used in the gum base.

The chewing gum compositions may include amounts of conventional additives selected from the group consisting of sweetening agents, plasticizers, softeners, emulsifiers, waxes, fillers, bulking agents, (carriers, extenders, bulk sweeteners), mineral adjuvants, flavor agents and coloring agents discussed above, antioxidants, acidulants, thickeners, medicaments, and the like, and mixtures thereof. Some of these additives may serve more than one purpose. For example, in sugarless gum compositions, a sweetener, such as maltitol or another sugar alcohol, may also function as a bulking agent.

Bulk sweeteners, such as sugars, sugarless bulk sweeteners, or the like, or mixtures thereof, generally are present in amounts of about 5% to about 95% by weight of the chewing gum composition.

Suitable sugar sweeteners generally include mono-saccharides, di-saccharides and poly-saccharides such as but not limited to, sucrose (sugar), dextrose, maltose, dextrin, xylose, ribose, glucose, mannose, galactose, fructose (levulose), invert sugar, fructo oligo saccharide syrups, partially hydrolyzed starch, corn syrup solids and mixtures thereof.

Suitable sugarless bulk sweeteners include sugar alcohols (or polyols) such as, but not limited to, sorbitol, xylitol, mannitol, galactitol, maltitol, hydrogenated isomaltulose (ISOMALT), lactitol, erythrytol, hydrogenated starch hydrolysate, stevia and mixtures thereof.

Suitable hydrogenated starch hydrolysates include those disclosed in U.S. Pat. Nos. 25,959, 3,356,811, 4,279,931 and various hydrogenated glucose syrups and/or powders which contain sorbitol, hydrogenated disaccharides, hydrogenated higher polysaccharides, or mixtures thereof. Hydrogenated starch hydrolysates are primarily prepared by the controlled catalytic hydrogenation of corn syrups. The resulting hydrogenated starch hydrolysates are mixtures of monomeric, dimeric, and polymeric saccharides. The ratios of these different saccharides give different hydrogenated starch hydrolysates different properties. Mixtures of hydrogenated starch hydrolysates, such as LYCASIN™, a commercially available product manufactured by Roquette Freres of France, and HYSTAR™, a commercially available product manufactured by Lonza, Inc., of Fairlawn, N.J., are also useful.

In some embodiments, high-intensity sweeteners also may be included in the confectionery compositions. Without being limited to particular sweeteners, representative categories and examples include:

(a) water-soluble artificial sweeteners such as soluble saccharin salts, i.e., sodium or calcium saccharin salts, cyclamate salts, the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, and mixtures thereof;

(b) dipeptide based sweeteners, such as L-aspartic acid derived sweeteners, such as L-aspartyl-L-phenylalanine methyl ester (Aspartame), N-[N-(3,3-dimethylbutyl)-L-α-aspartyl]-L-phenylalanine 1-methyl ester (Neotame), and materials described in U.S. Pat. No. 3,492,131, L-alphaaspartyl-N-(2,2,4,4-tetramethyl-3-thietanyl)-D-alaninamide hydrate (Alitame), methyl esters of L-aspartyl-L-phenylglycerine and L-aspartyl-L-2,5-dihydrophenyl-glycine, L-aspartyl-2,5-dihydro-L-phenylalanine; L-aspartyl-L-(1-cyclohexen)-alanine, and mixtures thereof;

(c) water-soluble sweeteners derived from naturally occurring water-soluble sweeteners, such as chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include but are not limited to: 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-1-deoxy-beta-D-fructo-f uranoside, or 4,1′-dichloro-4,1′-dideoxygalactosucrose; 1′,6′-dichloro 1′,6′-dideoxysucrose; 4-chloro-4-deoxy-alpha-D-galactopyranosyl-1,6-dichloro-1,6-dideoxy-beta-D-fructofuranoside, or 4,1′,6′-trichloro-4,1′, 6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideox y-beta-D-fructofuranoside, or 4,6,1′,6′-tetrachloro4,6,1′,6′-tetradeoxygalacto-sucrose; and 4,6,1′,6′-tetradeoxy-sucrose, and mixtures thereof; and

(d) protein based sweeteners such as thaumaoccous danielli (Thaumatin I and II).

The intense sweetening agents may be used in many distinct physical forms well-known in the art to provide an initial burst of sweetness and/or a prolonged sensation of sweetness. Without being limited thereto, such physical forms include free forms, such as spray dried, powdered, beaded forms, encapsulated forms, and mixtures thereof.

In general, an effective amount of intense sweetener may be utilized to provide the level of sweetness desired, and this amount may vary with the sweetener selected. The intense sweetener may be present in amounts from about 0.001% to about 3%, by weight of the composition, depending upon the sweetener or combination of sweeteners used. The exact range of amounts for each type of sweetener may be selected by those skilled in the art.

The plasticizers, softening agents, mineral adjuvants, waxes and antioxidants discussed above, as being suitable for use in the gum base, may also be used in the chewing gum composition. Examples of other conventional additives which may be used include emulsifiers, such as lecithin and glyceryl monostearate, thickeners, used alone or in combination with other softeners, such as methyl cellulose, alginates, carrageenan, xanthan gum, gelatin, carob, tragacanth, locust bean, and carboxy methyl cellulose, acidulants such as malic acid, adipic acid, citric acid, tartaric acid, fumaric acid, and mixtures thereof, and fillers, such as those discussed above under the category of mineral adjuvants.

Other conventional gum additives known to one having ordinary skill in the chewing gum art also may be used in the chewing gum compositions.

Active components which may be included in the swellable chewing gum compositions of the present invention include, but are not limited to, flavor agents and oral care actives. Other active components known to those skilled in the art, such as hydrophobic drugs, are considered well within the scope of the present invention.

Flavor agents which may be used include those flavors known to the skilled artisan, such as natural and artificial flavors. These flavorings may be chosen from synthetic flavor oils and flavoring aromatics and/or oils, oleoresins and extracts derived from plants, leaves, flowers, fruits, and so forth, and combinations thereof. Nonlimiting representative flavor oils include spearmint oil, cinnamon oil, oil of wintergreen (methyl salicylate), peppermint oil, clove oil, bay oil, anise oil, eucalyptus oil, thyme oil, cedar leaf oil, oil of nutmeg, allspice, oil of sage, mace, oil of bitter almonds, and cassia oil. Also useful flavorings are artificial, natural and synthetic fruit flavors such as vanilla, and citrus oils including lemon, orange, lime, grapefruit, and fruit essences including apple, pear, peach, grape, strawberry, raspberry, cherry, plum, pineapple, apricot and so forth. These flavoring agents may be used in liquid or solid form and may be used individually or in admixture. Commonly used flavors include mints such as peppermint, menthol, spearmint, artificial vanilla, cinnamon derivatives, and various fruit flavors, whether employed individually or in admixture.

Other useful flavorings include aldehydes and esters such as cinnamyl acetate, cinnamaldehyde, citral diethylacetal, dihydrocarvyl acetate, eugenyl formate, p-methylamisol, and so forth may be used. Generally any flavoring or food additive such as those described in Chemicals Used in Food Processing, publication 1274, pages 63-258, by the National Academy of Sciences, may be used. This publication is incorporated herein by reference.

Further examples of aldehyde flavorings include but are not limited to acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), cherry, grape, strawberry shortcake, and mixtures thereof.

In some embodiments, the flavor agent may be employed in either liquid form and/or dried form. When employed in the latter form, suitable drying means such as spray drying the oil may be used. Alternatively, the flavor agent may be absorbed onto water soluble materials, such as cellulose, starch, sugar, maltodextrin, gum arabic and so forth or may be encapsulated. The actual techniques for preparing such dried forms are well-known.

In some embodiments, the flavor agents may be used in many distinct physical forms well-known in the art to provide an initial burst of flavor and/or a prolonged sensation of flavor. Without being limited thereto, such physical forms include free forms, such as spray dried, powdered, beaded forms, encapsulated forms, and mixtures thereof.

Oral care actives which may be used include those actives known to the skilled artisan, such as, but not limited to, surfactants, breath freshening agents, anti-microbial agents, antibacterial agents, anti-calculus agents, anti-plaque agents, oral malodor control agents, fluoride compounds, quaternary ammonium compounds and combinations thereof.

Suitable surfactants include, but are not limited to, salts of fatty acids selected from the group consisting of C₈-C₂₄, palmitoleic acid, oleic acid, eleosteric acid, butyric acid, caproic acid, caprylic acid, capric acid, lauric acid, myristic acid, palmitic acid, stearic acid, ricinoleic acid, arachidic acid, behenic acid, lignoceric acid, cerotic acid, sulfated butyl oleate, medium and long chain fatty acid esters, sodium oleate, salts of fumaric acid, potassium glomate, organic acid esters of mono- and diglycerides, stearyl monoglyceridyl citrate, succistearin, dioctyl sodium sulfosuccinate, glycerol tristearate, lecithin, hydroxylated lecithin, sodium lauryl sulfate, acetylated monoglycerides, succinylated monoglycerides, monoglyceride citrate, ethoxylated mono- and diglycerides, sorbitan monostearate, calcium stearyl-2-lactylate, sodium stearyl lactylate, lactylated fatty acid esters of glycerol and propylene glycerol, glycerol-lactoesters of C₈-C₂₄ fatty acids, polyglycerol esters of C₈-C₂₄ fatty acids, propylene glycol alginate, sucrose C₈-C₂₄ fatty acid esters, diacetyl tartaric and citric acid esters of mono- and diglycerides, triacetin, sarcosinate surfactants, isethionate surfactants, tautate surfactants, pluronics, polyethylene oxide condensates of alkyl phenols, products derived from the condensation of ethylene oxide with the reaction product of propylene oxide and ethylene diamine, ethylene oxide condensates of aliphatic alcohols, long chain tertiary amine oxides, long chain tertiary phosphine oxides, long chain dialkyl sulfoxides, and combinations thereof.

Methods

The present invention also relates to a method of preparing a swellable chewing gum composition which may include the steps of:

a. providing a gum base; and

b. mixing the gum base with at least one water-gelling or water-swellable Si-containing component selected from the group consisting of silicates, silicas, and combinations thereof.

The gum base and the Si-containing component of the method of the present invention are as discussed herein.

### EXAMPLES

The following swellable chewing gum compositions were prepared in accordance with the present invention. In each of the examples below, to a previously prepared gum base was added each of the additional listed components.

TABLE 1
Chewing Gum Composition Containing Claytone Gelling Silicate

| Component | % by weight |
|---|---|
| Gum base | 29.4 |
| Sorbitol | 61.1 |
| Flavor | 2.0 |
| Sucralose | 0.5 |
| Claytone | 7.0 |
| Total | 100.0 |

TABLE 2
Chewing Gum Composition Containing Bentolite Gelling Silicate

| Component | % by weight |
|---|---|
| Gum base | 29.4 |
| Sorbitol | 61.1 |
| Flavor | 2.0 |
| Sucralose | 0.5 |
| Bentolite ® | 7.0 |
| Total | 100.0 |

TABLE 3
Chewing Gum Composition Containing Laponite Gelling Silicate

| Component | % by weight |
|---|---|
| Gum base | 29.4 |
| Sorbitol | 61.1 |
| Flavor | 2.0 |
| Sucralose | 0.5 |
| Laponite ® | 7.0 |
| Total | 100.0 |

TABLE 4
Chewing Gum Composition Containing Tixosil 43 Gelling Silicate

| Component | % by weight |
|---|---|
| Gum base | 29.4 |
| Sorbitol | 58.1.1 |
| Flavor | 2.0 |
| Sucralose | 0.5 |
| Tixosil 43 ® | 10.0 |
| Total | 100.0 |

TABLE 5
Chewing Gum Composition Containing Syloid 244 Gelling Silicate

| Component | % by weight |
|---|---|
| Gum base | 29.4 |
| Sorbitol | 58.1 |
| Flavor | 2.0 |
| Sucralose | 0.5 |
| Syloid 244 ® | 10.0 |
| Total | 100.0 |

TABLE 6
Chewing Gum Composition Without Si-Containing Component

| Component | % by weight |
|---|---|
| Gum base | 29.4 |
| Sorbitol | 58.1 |
| Flavor | 2.0 |
| Sucralose | 0.5 |
| Calcium Carbonate Filler | 10.0 |
| Total | 100.0 |

Each of the inventive compositions in Tables 2, 3, 5 and 6 were tested using an expert chew panel. The panel rated the compositions on a hedonic scale of 1 to 10 with respect to increased cud volume, and maintenance of softness, flavor intensity and at 1, 5, 10, and 20 minutes of chew. The results of these tests are provided below.

Chew Panel Results

Flavor Intensity

Flavor intensity of chewing gums containing different filler were evaluated by five chew expert panel, 0 being lowest and 10 being highest in favor intensity. Average values are reported here.

TABLE 7
Flavor intensity of chewing gums containing hydrophilic fillers

| Chewing gum | | | | | |
|---|---|---|---|---|---|
| Compositions | Filler Type | 1 min | 5 min | 10 min | 20 min |
| 2 | Laponite (7%) | 8 | 5 | 5 | 4 |
| 3 | Bentolite (7%) | 8 | 5 | 5 | 3 |
| 5 | Syloid 244 (10%) | 8 | 6 | 5 | 5 |
| 6 | Calcium Carbonate | 8 | 5 | 4 | 1 |
| | (10%) (control) | | | | |

Gum Texture Evaluations

Five expert panels chewed the gums for 1, 5, 10 and 20 minutes. The softness of th masticated gums were rated on a scale of 0-10, with ten (10) being the softest and zero (0) being the hardest. Average values are reported.

TABLE 8
softness of chewing gums containing different fillers

| Chewing gum | | | | | | |
|---|---|---|---|---|---|---|
| Compositions | Filler Type | 0 min | 1 min | 5 min | 10 min | 20 min |
| 2 | Laponite (7%) | 4 | 6 | 7 | 7.5 | 8 |
| 3 | Bentolite (7%) | 4 | 6 | 6 | 7.5 | 7.5 |
| 5 | Syloid 244 | 3 | 5 | 6 | 6.7 | 7 |
| | (10%) | | | | | |
| 6 | Calcium | 4 | 6 | 6 | 5 | 4 |
| | Carbonate | | | | | |
| | (10%) (control) | | | | | |

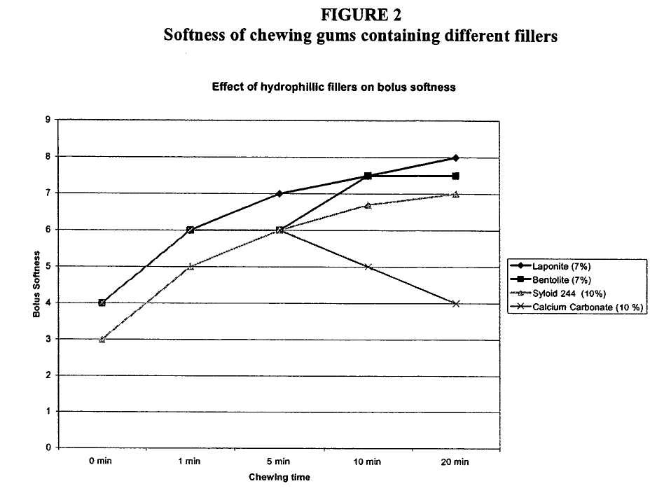

As indicated in Table 8, each of inventive Compositions 2, 3 and 5 had high softness ratings after ten (10) and twenty (20) minute chew periods as compared to the control. At the ten (10) minute chew period, each of the inventive compositions had between 17% and 25% greater softness ratings; and after the twenty (20) minute period, the inventive compositions had between 30% and 40% greater ratings than the control. This table is depicted graphically in FIG. 2.

Gum Swelling Measurements

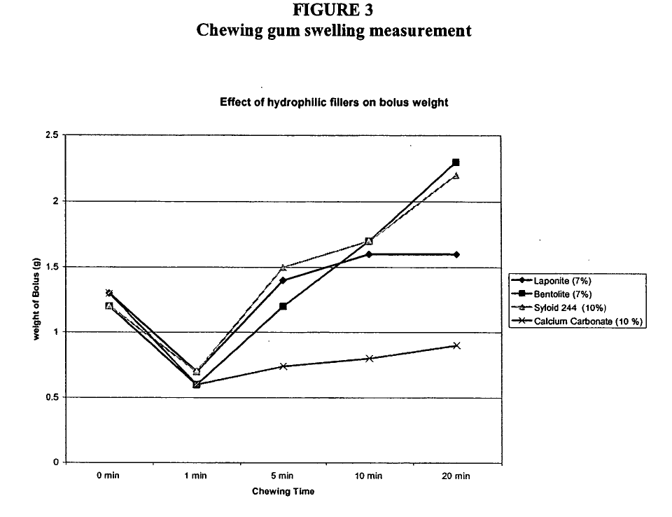

Chewing gums containing different silicon-containing filler components were evaluated for volume increase. The compositions correspond to Compositions 2, 3, 5 and 6 of the prior examples. The chewing gums were weighed after 1, 5, 10 and 20 min of mastication. Average values were reported. This Table is depicted graphically in FIG. 3.

TABLE 9
Chewing gum swelling measurement

| Chewing Gum | | | | | | |
|---|---|---|---|---|---|---|
| Composition | Filler Type | 0 min | 1 min | 5 min | 10 min | 20 min |
| 2 | Laponite (7%) | 1.3 | 0.7 | 1.4 | 1.6 | 1.6 |
| 3 | Bentolite (7%) | 1.2 | 0.6 | 1.2 | 1.7 | 2.3 |
| 5 | Syloid 244 | 1.2 | 0.7 | 1.5 | 1.7 | 2.2 |
| | (10%) | | | | | |
| 6 | Calcium | 1.3 | 0.6 | 0.74 | 0.8 | 0.9 |
| | Carbonate | | | | | |
| | (10%) | | | | | |

As can be seen from Table 9, the inventive compositions showed significant increase in bolus weight: Compositions 2, 3 and 5 showed significant increase of bolus weight as compared to the weight prior to hydration (i.e. pre-mastication). While composition 6 (control) showed minor increase of bolus weight as compared to the weight prior to hydration.

Table I shows the results of flavor intensity chew panels performed on inventors Compositions 2, 3 and 5 as compared to Control Composition 6. Flavor intensity was measured after intervals of one (1), five (5), ten (10) and twenty (20) minuts. As indicated by the graph, the inventive compositions were rated as having signifcantly higher flavor intensity after 5, 10 and 20 minutes of chew time, indicating the ability of the inventive compositions to continue to release higher flavor levels as compared to comparable compositions without the silicon-containing compounds.

What is claimed is:

1. A swellable chewing gum composition comprising:
a. a gum base; and
b. at least one water-gelling or water-swellable silicon-containing component selected from the group consisting of silicates, silicas, and combinations thereof.

2. The swellable chewing gum composition of claim 1, wherein the gum base includes at least one elastomer selected from the group consisting of natural rubber, styrene-butadiene copolymers (SBR), polyisobutylene, isobutylene-isoprene copolymers, polyethylene, polyvinyl acetate, crosslinked polyvinyl pyrrolidone, copolymers of lactic acid, polyhydroxyalkanoates, plasticized ethylcellulose, polyvinyl acetatephthalate, and combinations thereof.

3. The chewing gum composition of claim 1, wherein the silicon-containing component is derived from southern clay.

4. The chewing gum composition of claim 1, wherein the silicon-containing component is a synthetic clay.

5. The chewing gum composition of claim 1, wherein the silicate is present in an amount of about 0.1% to about 50% by weight of the composition.

6. The chewing gum composition of claim 1, wherein the silicate is present in an amount of about 2% to about 10% by weight of the composition.

7. The chewing gum composition of claim 1, wherein the composition, when swollen, is about 1% to about 300% larger in volume.

8. The chewing gum composition of claim 1, wherein when swollen, is about 25% to about 200% larger in volume.

9. The chewing gum composition of claim 1, further comprising one or more components selected from the group consisting of sweetening agents, physiological cooling agents, warming agents, sensates and combinations thereof.

10. The chewing gum composition of claim 1, further comprising one or more components selected from the group consisting of flavor agents, coloring agents and combinations thereof.

11. A method of preparing a swellable chewing gum composition comprising:
a. providing a gum base; and
b. mixing the gum base with at least one water-gelling or water-swellable silicon-containing component selected from the group consisting of silicates, silicas, and combinations thereof.

12. The method of claim 11, wherein the silicon-containing component is present in an amount of about 0.1% to about 50% by weight of the composition.

13. The method of claim 11, wherein the silicon-containing component is present in an amount of about 2% to about 10% by weight of the composition.

14. The method of claim 6, wherein the silicon-containing component comprises a gelling silicate having a SiO₂ content of at least about 50% by weight of the silicon-containing compositions.

15. A method of increasing the cud volume of a chewing gum composition comprising:
a. providing a gum base; and
b. mixing the gum base with at least one water-gelling or water-swellable silicon-containing component selected from the group consisting of silicates, silicas, and combinations thereof.

16. A method of maintaining the softness of a chewing gum composition over an extended chew time comprising:
a. providing a gum base; and
b. mixing the gum base with at least one water-gelling or water-swellable silicon-containing component selected from the group consisting of silicates, silicas, and combinations thereof.

17. A method of increasing the bolus weight of a chewing gum composition comprising:
a. providing a gum base;
b. mixing the gum base with at least one water-gelling or water-swellable silicon-containing component selected from the group consisting of silicates, silicas, and combinations thereof; and
c. exposing the thus formed chewing gum composition to mastication to permit moisture absorption and consequent bolus weight gain.

18. A composition comprising a chewable matrix and about 0.1 to about 50% by weight of the composition a water-gelling or water-swellable silicon-containing component.

19. A chewing gum composition comprising:
a. a gum base; and
b. a water-gelling or water-swellable silicon-containing component,
wherein upon exposure to moisture, exhibits one or more of the following characteristics: an increase in volume of about 1% to about 300%; and an increase in weight from about 10% to about 350% by weight of the total composition.
